(19) United States
(12) Patent Application Publication
(10) Pub. No.: US 2019/0329336 A1
(43) Pub. Date: Oct. 31, 2019

(54) POWER TOOL SUPPORT AND SYSTEM CONTAINING THE SAME

(71) Applicant: TTI (MACAO COMMERCIAL OFFSHORE) LIMITED, Macau (MO)

(72) Inventor: Wai Tong CHAN, Kwai Chung (HK)

(21) Appl. No.: 16/394,509

(22) Filed: Apr. 25, 2019

(30) Foreign Application Priority Data
Apr. 28, 2018 (CN) 201820628452.8

(51) Int. Cl. B23D 47/02; B25H 1/04

(52) U.S. Cl. CPC B23D 47/025; B25H 1/04

(57) ABSTRACT

A power tool stand includes a stand body, a slide rail mounted to the stand body, and a first holder and a second holder coupled to the slide rail and slidable along the slide rail. The first holder and the second holder are adapted to maintain a relative distance between the first holder and the second holder substantially fixed by a locking device. By using the locking device, after fixing one holder, the user can conveniently fix the other holder to the slide rail at a predetermined distance in a fool-proof way.

### FIELD

The invention relates to a stand/worktable of a power tool, in particular to a holder for mounting other components on the stand.

### BACKGROUND

Miter saws are commonly used woodworking power tools. Its main feature is that the rotating saw wheel can be pressed vertically downwardly to cut the workpiece, and the saw wheel can be tilted to a certain extent to the left and right sides, so as to achieve a variety of cutting effects. The miter saw is typically mounted on a stand that matches the height of the user's body so that the user does not need to kneel or sit down to perform the miter saw operation. On the stand, there is a movable holder for mounting the miter saw body, and holders for additional components such as those for mounting workpiece limiting members and the like. The above-described stands and holder and the like are generally designed to be foldable/removable, thereby enabling the user to conveniently fold the entire work platform for storage, or for transportation, etc.

However, in conventional art, after the miter saw stand is folded for storage or transportation, before it is ready for the normal operation of the miter saw, the stand needs to be reconfigured so that the miter saw can be correctly fixed and mounted on the stand. Each such reconfiguration requires the user to spend a lot of time and effort to reposition the stand to ensure that the distance between different holders on the stand is normal. For example, it is necessary to ensure that the distance between the holder of the miter saw body and the holder of the workpiece limiting component is at a preset value, otherwise it will give rise to a problem that the positioning of the workpiece to be cut is inaccurate and thus the machining precision is reduced. Such configuration and correction works are burdensome for the user.

### SUMMARY

Accordingly, embodiments of the present invention provide a power tool stand including a stand body, a slide rail mounted to the stand body; and a first holder and a second holder connected to the slide rail and slidable along the slide rail. The first holder and the second holder are adapted to maintain a relative distance between the first holder and the second holder substantially fixed by a locking device.

Preferably, when the first holder and the second holder are held by the locking device to maintain the relative distance fixed, the first holder and the second holder can still slide along the slide rail together.

More preferably, the locking device contains a first portion disposed on the first holder and a second portion disposed on the second holder. The first portion and the second portion are mechanically coupled to fix the relative distance.

In a specific embodiment, the first portion contains a primary locking tongue extending along a length of the slide rail and the second portion includes a groove formed on the second holder. The primary locking tongue is adapted to be inserted into the groove to at least partially fix the relative distance.

In another embodiment, the first portion further contains a secondary locking tongue extending along the slide rail direction. The secondary locking tongue is adapted to abut an edge of the second holder different from the groove to partially fix the relative distance.

Another aspect of the present invention provides a power tool system including the above-described power tool stand, a power tool mounted to the power tool stand, and a workpiece limiting member mounted to the power tool stand.

Preferably, the power tool is miter saw.

The power tool stand provided by the invention can thus alleviate the burden of the user on manually correcting the holder on the slide rail carrying different components every time like the stand in the prior art. By using the locking device, after fixing one holder the user can conveniently fix the other holder to the slide rail at a predetermined distance in a fool-proof way directly, which does not require any cumbersome or time-consuming setting process. Such a convenience is not only provided to the process of changing the stand from a folded state to a complete unfolded state, but also when relative displacement of the workpiece limiting member and the power tool itself is caused by the long-term use of the electric tool.

### BRIEF DESCRIPTION OF THE DRAWINGS

The performance and advantages of the present invention will be further understood by reference to the remainder of the specification and the accompanying drawings;

FIG. 1 shows a perspective external view of a power tool stand on which a miter saw, a workpiece limiting member, and a workpiece (wood) are mounted, in accordance with an embodiment of the present invention.

FIG. 2 partially shows the position of the two holders on the power tool stand of FIG. 1.

FIG. 3a and FIG. 3b show, at different angles, respectively, how the relative distance between the two holders on the power tool stand of FIG. 2 is locked by the locking members.

FIG. 4 shows separately the appearance of the locking member of FIG. 3a and FIG. 3b.

### DETAILED DESCRIPTION

Embodiments of the present invention make use of interlocking locking tongues and grooves to lock the two holders. Other different benefits and advantages provided by the various embodiments of the present invention are readily apparent from the following description.

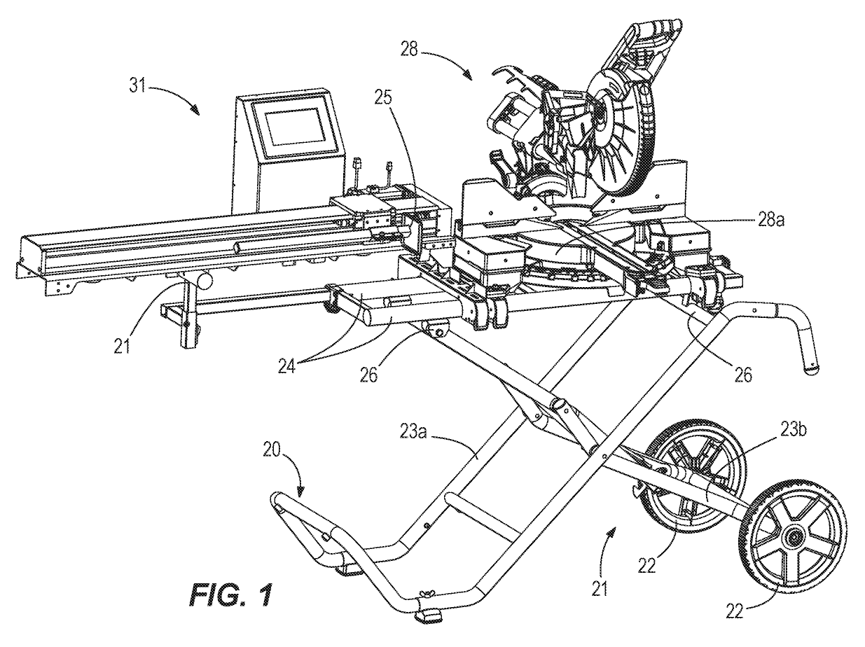

Turning first to FIG. 1, in which a power tool stand 21 is shown. The power tool stand 21 has a foldable structure, and FIG. 1 shows its fully unfolded state. Specifically, the power tool stand 21 includes a first stand 23a and a second stand 23b which are coupled together by a hinge (not shown) in a relatively rotatable manner. The first stand 23a and the second stand 23b together constitute a stand body. At one end of the first stand 23a, a grip portion 20 for gripping by a user is formed. At one end of the second stand 23b, a wheel 22 is disposed. The other end of the second stand 23b and the other end of the first stand 23a are respectively connected to the two ends of two mutually parallel slide rails 24 by two pivotable connecting members 26. With the above structure, the power tool stand 21 can be folded to become a flat-like structure to facilitate the user to push the power tool stand 21 to move on the ground through the wheels 22. Alternatively, the user can also unfold the power tool stand 21 into the state shown in FIG. 1, where the wheel 22 and the grip 20 become a fulcrum on which the entire power tool stand 21 stands on the ground. On the slide rail 24, a power tool, in this embodiment a miter saw 28, is supported. In addition, on the slide rail 24, a workpiece limiting member 31 is also carried. The main structure and folding manner of the power tool stand 21 described above are well-known to those skilled in the art and will not be described herein.

A workpiece (not shown) to be cut is placed on the worktable 28a of the miter saw 28, and one end of the workpiece abuts against one end of a support arm 25 of the workpiece limiting member 31. By adjustment of the position of the support arm 25 of the workpiece limiting member 31, it assists the user in accurately positioning the portion of the workpiece to be cut by the miter saw 28. The working principle and structure of the workpiece limiting member 31 are also well-known to those skilled in the art and will not be described herein. It should be noted that in order to accurately position the portion to be cut by the miter saw 28, it is also necessary to set the distance between the workpiece limiting member 31 and the miter saw 28. This is precisely determined by the locking device described below.

Turning now to FIG. 2, in which a portion of the power tool stand 21 of FIG. 1 is shown. Specifically, on the slide rail 24 (only one slide rail 24 is shown in FIG. 2), two holders 32, 34 are mounted. Wherein, the first holder 32 is for partially carrying the above-mentioned workpiece limiting member 31 (not shown in FIG. 2), and the second holder 34 is for partially carrying the above-mentioned miter saw 28 (not shown in FIG. 2). The first holder 32 and the second holder 34 are slidably bridged over the two slide rails 24 and supported by the slide rails 24. Each one of the first holder 32 and the second holder 34 can be individually locked to the slide rail 24. This is accomplished by a latch 36 at one end of the first holder 32 and the second holder 34. FIG. 2 also shows a portion of the support structure 38 that is mounted on the second holder 34. The support structure 38 is used to further support the miter saw 28 (not shown in FIG. 2).

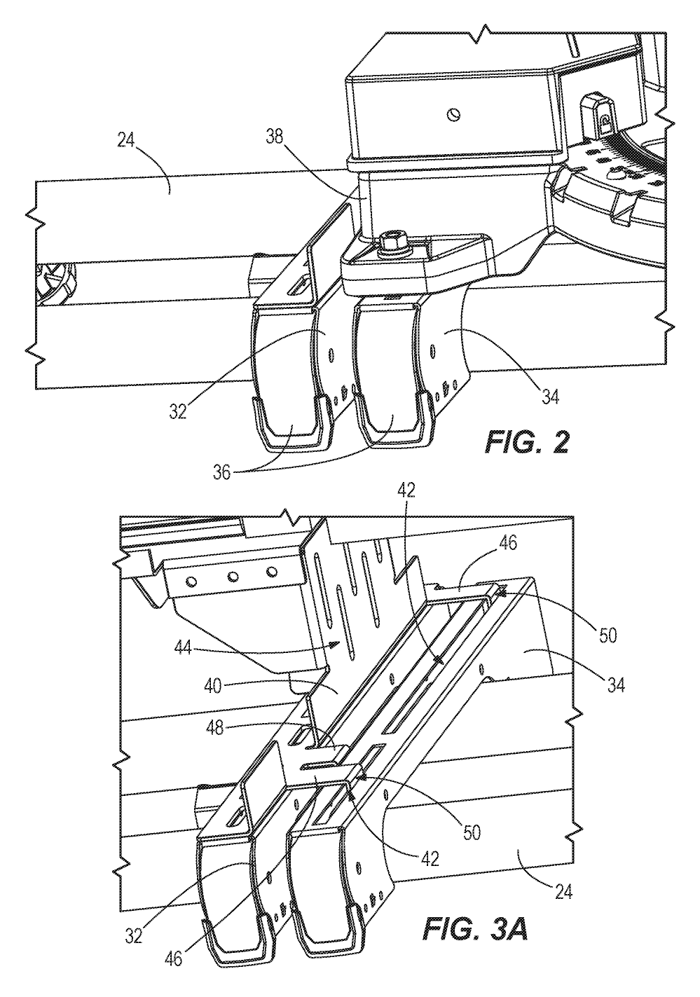

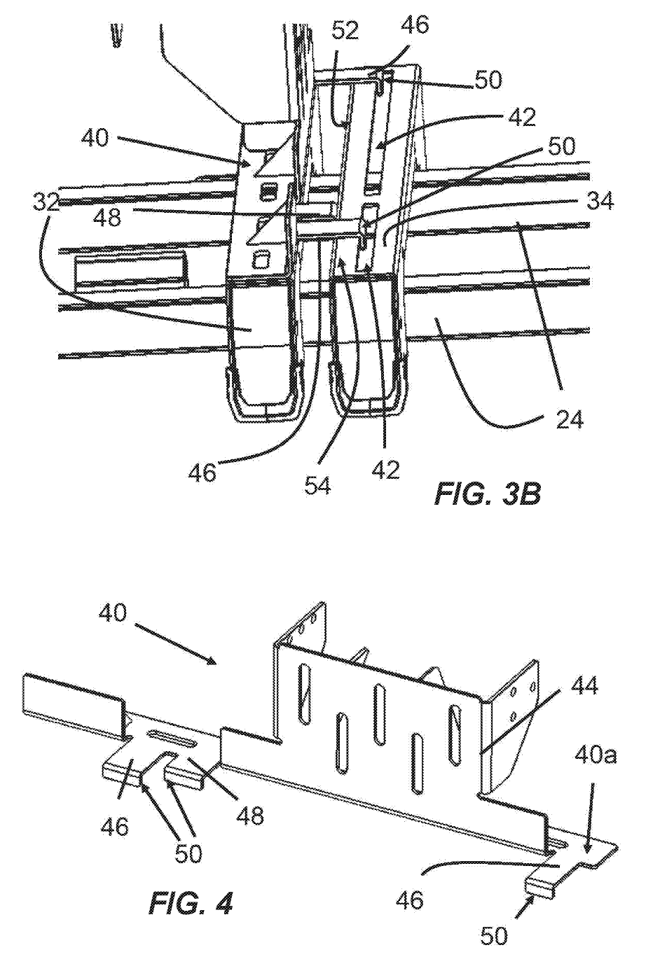

Now look at FIG. 3a-FIG. 4. For clarity, the support structure 38 described above is hidden in FIG. 3a-FIG. 3b, thereby clearly showing the top surface arrangement of the second holder 34. The first holder 32 and the second holder 34 in this embodiment are fixed together by a locking device, and in particular the relative distance between them is kept fixed. It can be seen from FIG. 3a-FIG. 3b that each one of the first holder 32 and the second holder 34 has a shape similar to a bridge. They are respectively bridged over two parallel rails 24 and kept parallel to each other. The locking device includes a locking piece 40 disposed on a top surface of the first holder 32 and two grooves 42 disposed on a top surface of the second holder 34. Both the groove 42 and the locking piece 40 extend in a direction perpendicular to the longitudinal direction of the slide rail 24. As best shown in FIG. 4, the body 40a of the locking piece 40 is sheet-like, and it has substantially the same length as the first holder 32 and the second holder 34. Certain portions of the body 40a have locking tongues 46, 48 that extend in a horizontal direction. As can be seen in FIG. 4, there are two primary locking tongues 46 and one secondary locking tongue 48, and the length of the primary locking tongues 46 is greater than the length of the secondary locking tongue 48. A hook 50 is formed at the front end of both the primary locking tongues 46 and the secondary locking tongue 48. Further, on the main body 40a, a connecting piece 44 extending vertically upward is also formed. The connecting piece 44 is used to connect the above-mentioned workpiece limiting member.

FIG. 3a-FIG. 3b clearly show how the locking piece 40 on the first holder 32 cooperates with the two grooves 42 on the second holder 34 to create a mechanical connection to lock the relative distance between the first holder 32 and the second holder 34. The hooks 50 at the ends of the two primary locking tongues 46 are each inserted into a corresponding groove 42. Since the groove 42 has a small width, when the hook 50 is inserted into the groove 42, the hook 50 can barely be moved therein with any freedom, either forward or backward (both parallel to the length of the slide rail 42). Since the locking piece 40 is fixed to the first holder 32, the relative distance between the first holder 32 and the second holder 34 is kept substantially fixed. In order to further improve the accuracy of the relative distance between the first holder 32 and the second holder 34, and to avoid tolerance caused by the width of the groove 42, the secondary locking tongue 48 is also used to abut against the rear edge 52 of the second holder 34 towards the first holder 32. This edge is different from any edge defined by the groove 42 on the second holder 34. Since the secondary locking tongue 48 and the primary locking tongue 46 are fixed to each other, the distance between the hooks 50 of both of them is designed to be directly accommodating a section 54 on the second holder 34, which is defined by the rear edge 52 and the groove 42 described above. As such, floating in the relative distance between the first holder 32 and the second holder 34 is minimized because the secondary lock tongue 48 and the primary lock tongue 46 collectively limit such floating.

The above locking device can be adapted to quickly configure the relative distance between the miter saw 28 and the workpiece limiting member 31 when the power tool stand 21 is switched from the folded state to the unfolded (operating) state, so that the user can accurately position the part to be cut of the workpiece set by the workpiece limit element 31. In addition, even if such positioning has been made, during the operation of the long-term miter saw 28, due to the continuous need for the user to place the workpiece against the workpiece limiting member 31, the impact force continues to force the miter saw 28 and the workpiece limiting member 31 to generate a trend of separating from each other. However, such separation is inhibited due to the presence of the locking means such that the relative distance between the first holder 32 and the second holder 34 can be accurately maintained.

Therefore, after describing the embodiments of the invention, it will be understood by those skilled in the art that various modifications, and other structures and equivalents may be used without departing from the spirit of the invention. Accordingly, the above description should not be taken as limiting the scope of the invention as defined by the following claims.

For example, although the power tool mounted on the power tool stand in the above embodiment is a miter saw, those skilled in the art will recognize that other types of power tools can also be mounted to the power tool stand to which the present invention is applied. For example, the power tool can be a circular saw, a table saw, or the like.

Further, although the above embodiment specifically shows a locking device composed of a locking tongue and a groove, the present invention is not limited to this specific structure. Other types of locking devices will also fall within the scope of the present invention as long as they are also used to maintain the distance of two holders that would otherwise be able to slide independently of one another.

1. A power tool stand, comprising:
a stand body;
a slide rail mounted to the stand body;
a first holder and a second holder connected to the slide rail and slidable along the slide rail; and
a locking device configured to maintain a substantially fixed relative distance between the first holder and the second holder.

2. The power tool stand of claim 1, wherein when the first holder and the second holder are held by the locking device to maintain the relative distance fixed, the first holder and the second holder are adapted to slide along the slide rail together.

3. The power tool stand of claim 2, wherein the locking device comprises a first portion disposed on the first holder and a second portion disposed on the second holder; the first portion and the second portion are mechanically coupled to fix the relative distance.

4. The power tool stand of claim 3, wherein the first portion comprises a primary locking tongue extending along a length of the slide rail and the second portion comprises a groove formed on the second holder; the primary locking tongue adapted to be inserted into the groove to at least partially fix the relative distance.

5. The power tool stand of claim 4, wherein the first portion further comprises a secondary locking tongue extending along a direction of the slide rail; the secondary locking tongue adapted to abut an edge of the second holder different from the groove to partially fix the relative distance.

6. A power tool system, comprising:
a power tool stand including
a stand body,
a slide rail mounted to the stand body,
a first holder and a second holder connected to the slide rail and slidable along the slide rail, and
a locking device configured to maintain a substantially fixed relative distance between the first holder and the second holder:
a power tool mounted to the power tool stand; and
a workpiece limiting member mounted to the power tool stand.

7. The power tool system of claim 6, wherein the power tool is a miter saw.

8. The power tool system of claim 6, wherein when the first holder and the second holder are held by the locking device to maintain the relative distance fixed, the first holder and the second holder are adapted to slide along the slide rail together.

9. The power tool system of claim 8, wherein the locking device comprises a first portion disposed on the first holder and a second portion disposed on the second holder; the first portion and the second portion are mechanically coupled to fix the relative distance.

10. The power tool system of claim 9, wherein the first portion comprises a primary locking tongue extending along a length of the slide rail and the second portion comprises a groove formed on the second holder; the primary locking tongue adapted to be inserted into the groove to at least partially fix the relative distance.

11. The power tool system of claim 10, wherein the first portion further comprises a secondary locking tongue extending along a direction of the slide rail; the secondary locking tongue adapted to abut an edge of the second holder different from the groove to partially fix the relative distance.

12. The power tool system of claim 11, wherein the workpiece limiting member is mounted to the first holder, and wherein the power tool is mounted to the second holder.

13. The power tool system of claim 11, wherein the first portion of the locking device comprises a locking piece having a flat body mounted to the first holder, and wherein the primary and secondary locking tongues extend from the locking piece body toward the second holder.

14. The power tool system of claim 13, wherein the primary and secondary locking tongues extend from the locking piece body in a horizontal direction, and wherein each of the primary and secondary locking tongues includes a hook engaged with the second holder.

15. The power tool system of claim 14, wherein the hook of the primary locking tongue is received within the groove formed on a top surface of the second holder, and wherein the hook of the secondary locking tongue is abutted against the edge of the second holder.

16. The power tool system of claim 6, wherein the workpiece limiting member is mounted to the first holder, and wherein the power tool is mounted to the second holder.

17. The power tool system of claim 16, wherein the power tool is a miter saw, and wherein the workpiece limiting member includes a support arm that is adjustable relative to the miter saw against which a workpiece supported on the miter saw is abuttable.

18. The power tool stand of claim 5, wherein the first portion of the locking device comprises a locking piece having a flat body mounted to the first holder, and wherein the primary and secondary locking tongues extend from the locking piece body toward the second holder.

19. The power tool system of claim 18, wherein the primary and secondary locking tongues extend from the locking piece body in a horizontal direction, and wherein each of the primary and secondary locking tongues includes a hook engaged with the second holder.

20. The power tool system of claim 19, wherein the hook of the primary locking tongue is received within the groove formed on a top surface of the second holder, and wherein the hook of the secondary locking tongue is abutted against the edge of the second holder.
